(19) United States
(12) Patent Application Publication
(10) Pub. No.: US 2008/0077564 A1
(43) Pub. Date: Mar. 27, 2008

(54) DOCUMENT-SEARCH SUPPORTING APPARATUS AND COMPUTER PROGRAM PRODUCT THEREFOR

(75) Inventor: Masakazu Hattori, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/851,264

(22) Filed: Sep. 6, 2007

(30) Foreign Application Priority Data
Sep. 27, 2006 (JP) 2006-263114

(51) Int. Cl. G06F 17/30

(52) U.S. Cl. 707/3; 707/E17.014

(57) ABSTRACT

A user is prompted to select two source queries. By using each of the two selected source queries, a searching process is performed on a structured document database so that source query results are presented to the user. With regard to predetermined structural parts from the source query results obtained by using the two source queries, when the predetermined structural part from one of the two source query results is dragged and dropped onto the predetermined structural part from the other of the two source query results, the predetermined structural parts from the source query results obtained by using the two source queries are brought into correspondence with each other. Accordingly, a target query that is a new query as well as a search result obtained by using the target query are generated.

### CROSS-REFERENCE TO RELATED APPLICATIONS

This application is based upon and claims the benefit of priority from the prior Japanese Patent Application No. 2006-263114, filed on Sep. 27, 2006; the entire contents of which are incorporated herein by reference.

### BACKGROUND OF THE INVENTION

1. Field of the Invention

The present invention relates to a document-search supporting apparatus and a computer program product therefor.

2. Description of the Related Art

In recent years, a number of approaches have been proposed as to provide a support in a search performed on a structured document that has a hierarchical logical structure.

A first example of a search support is to provide a support at a syntax level, e.g., a Structured Query Language (SQL) editor. When such a search support is used, it is possible to provide a support for a user in making a search formula at a syntax level by, for example, checking the syntax and complementing keywords.

A second example of a search support is to provide a support at a process level, e.g., Query By Example (QBE) that is an interface (I/F) for allowing a database to be used in an interactive manner. When such a search support is used, a table in a Relational Database (RDB) is shown as an example. The user is able to generate SQL by inputting criterion into the table. Thus, this support makes it easier to generate SQL than in a case where SQL is generated from scratch.

A third example of a search support is to provide a support in a generation process by correcting search formulae. An example of such a technique is disclosed in Japanese Patent No. 3612914. Japanese Patent No. 3612914 discloses a method for generating a plurality of more moderate search formulae by using a rewriting rule and a reference accuracy indicating a level of accuracy, after a user has input a search formula in which a plurality of items out of the following are written: the types of the nodes in the structure of a structured document, the contents of the nodes, the attributes of the nodes, and the structural relationship among the nodes.

A fourth example of a search support is to provide a support in a generation process by synthesizing a search formula. An example of such a technique is disclosed in Japanese Patent No. 3168829. The technique disclosed in Japanese Patent No. 3168829 provides a search formula generation supporting system that includes a structure extracting process for extracting, as a search result for a structured document, a first partial structure of the structured document that includes a second partial structure, based on the second partial structure presented by a user as an example; and a search formula synthesizing process for obtaining a search formula by synthesizing the partial structure extracted in the structure extraction process.

In the first and the second examples of the search supports, namely, the support at the syntax level and the support at the process level, information related to the syntax and information related to the data structures (i.e., the schemas) are required, respectively. Thus, it is difficult for general users to try using these search supports. Also, when data having various schemas such as a structured document database (DB) is dealt with, it is impossible to acquire sufficient prerequisite knowledge of schemas. In addition, like in the example of the tables in a RDB, it is not possible to narrow down the tables to be shown as examples to one table. Thus, it is difficult for general users to use the search supports.

In other words, the first and the second examples of the search supports have a problem where it is difficult for general users to use the search supports because the users are required to have information related to the syntax or the information related to the schemas.

Further, in the third example of the search support, namely, the support in the generating process of a search formula provided by making corrections, which is disclosed in Japanese Patent No. 3612914, it is difficult to prepare an accurate conversion rule for search formulae in advance. In addition, in this case also, the user is required to have prerequisite knowledge of schemas.

Furthermore, in the fourth example of the search support, namely, the support in the generating process provided by synthesizing the search formula, which is disclosed in Japanese Patent No. 3168829, it is necessary to prepare an extremely large number of detailed synthesis rules in advance. In addition, this search support has another problem where it is possible to generate only simple search formulae in spite of all the preparation. Moreover, it is difficult to generate a complex search formula through an intuitive operation.

In other words, the third and the fourth examples of the search supports have problems where the search support does not work well unless a large number of synthesis rules or conversion rules are prepared in advance on the system side.

In view of these problems, it is an object of the present invention to provide a document-search supporting apparatus and a computer program product therefor that do not require the preparation of an extremely large number of detailed synthesis rules in advance before a new query (i.e., a search formula) is generated, that also do not require users to have basic knowledge such as information related to syntax and information related to data structures (i.e., schemas), and that allow users to generate a complex query by repeatedly performing a simple operation.

### SUMMARY OF THE INVENTION

According to one aspect of the present invention, a document-search supporting apparatus includes a query storing unit that stores queries to be used in a searching process into a storage unit, the searching process being performed on a structured document database that has a hierarchical logical structure and stores a structured document; a correlating unit that selects predetermined structural parts of source query results and correlates the selected predetermined structural parts one another, by using at least two of the queries; a query-logic extracting unit that extracts partial graphs respectively related to the correlated two of the predetermined structural parts of the source query results as query logics; a query-logic mapping unit that generates a correlating relationship between the query logics; and a query generating unit that generates a new query by converting the queries corresponding to the source query results selected by the correlating unit, based on the generated correlating relationship.

According to another aspect of the present invention, a computer program product having a computer readable medium including programmed instructions for supporting generation of queries to be used in a searching process performed on a structured document database that has a hierarchical logical structure and stores a structured document, wherein the instructions, when executed by a computer, cause the computer to perform: storing the queries into a storage unit; selecting predetermined structural parts of source query results and correlating the selected predetermined structural parts one another, by using at least two of the queries; extracting partial graphs respectively related to the correlated two of the predetermined structural parts of the source query results as query logics; generating a correlating relationship between the query logics; and generating a new query by converting the queries corresponding to the source query results selected in the selecting, based on the generated correlating relationship.

### BRIEF DESCRIPTION OF THE DRAWINGS

FIG. 1 is a block diagram according to a first embodiment of the present invention;

FIG. 2 is a block diagram of a schematic configuration;

FIG. 3 is schematic drawing of an example of structured document data;

FIG. 4 is a schematic drawing of an example showing how the structured document data shown in FIG. 3 is stored;

FIG. 5 is a schematic drawing of an example of a query;

FIG. 6 is a schematic drawing of a result obtained by executing the query;

FIG. 7 is a schematic drawing for explaining how the result is output;

FIG. 8 is a schematic drawing of another example of a query that is different from the one shown in FIG. 5;

FIG. 9 is a schematic drawing for explaining how the result is output;

FIG. 10 is a flowchart of a procedure in a document-search supporting process;

FIG. 11 is a front view of an example of query execution results;

FIG. 12 is a schematic drawing of an example of a user operation;

FIG. 13 is a schematic drawing of query logics;

FIG. 14 is a schematic drawing of a query;

FIG. 15 is a schematic drawing of an execution result;

FIG. 16 is a schematic drawing for simply explaining a flow in a generation process of a new query;

FIG. 17 is a front view of an example in which a plurality of query execution results are displayed in a list;

FIG. 18 is a schematic drawing of an example of a query according to a second embodiment of the present invention;

FIG. 19 is a schematic drawing of an example of a user operation;

FIG. 20 is a schematic drawing of query logics;

FIG. 21 is a flowchart of an operation performed by a query-logic mapping unit;

FIG. 22 is a drawing for illustratively explaining matching candidates;

FIG. 23 is a schematic drawing of a query;

FIG. 24 is a schematic drawing of an execution result;

FIG. 25 is a schematic drawing for explaining how the result is output;

FIG. 26 is a schematic drawing of an example in which a plurality of matching candidates are presented;

FIG. 27 is a schematic drawing of an example of a query according to a third embodiment of the present invention;

FIG. 28 is a schematic drawing of an example of a user operation;

FIG. 29 is a schematic drawing of a new query; and

FIG. 30 is a schematic drawing of an execution result.

### DETAILED DESCRIPTION OF THE INVENTION

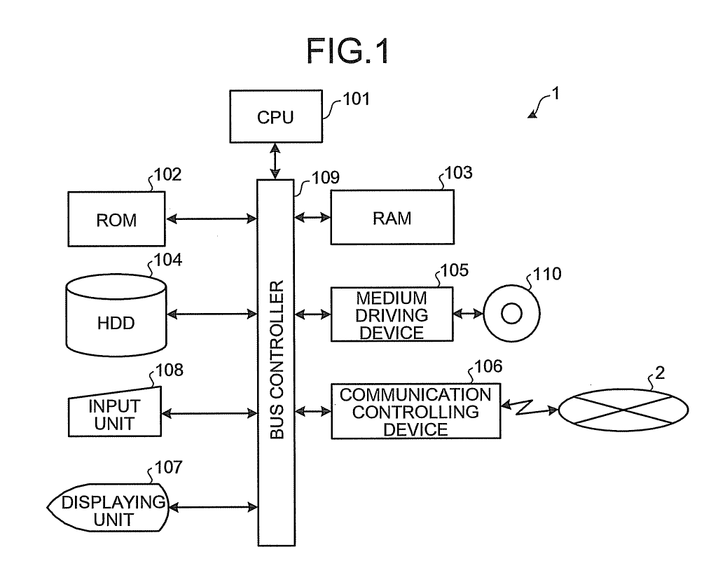

A first embodiment of the present invention will be explained with reference to FIGS. 1 to 15. FIG. 1 is a block diagram of a document-search supporting apparatus 1 according to the first embodiment. The document-search supporting apparatus 1 is, for example, a commonly-used personal computer.

As shown in FIG. 1, the document-search supporting apparatus 1 includes a Central Processing Unit (CPU) 101 that performs information processing; a Read Only Memory (ROM) 102 that stores therein a Basic Input/Output System (BIOS) and the like; a Random Access Memory (RAM) 103 that stores therein various types of data in a rewritable manner; a Hard Disk Drive (HDD) 104 that functions as various types of databases and also stores therein various types of programs; a medium driving device 105 like a Compact Disk Read Only Memory (CD-ROM) drive that is used for storing information, distributing information to the outside of the document-search supporting apparatus 1, and obtaining information from the outside of the document-search supporting apparatus 1, with the use of a storage medium 110; a communication controlling device 106 used for transmitting information to other computers on the outside of the document-search supporting apparatus 1 through communication via a network 2; a displaying unit 107 such as a Cathode Ray Tube (CRT) or a Liquid Crystal Display (LCD) that displays the progress or a result of a process to an operator; and an input unit 108 such as a keyboard or a mouse that is used by an operator to input an instruction or information to the CPU 101. The document-search supporting apparatus 1 operates while a bus controller 109 arbitrates the data transmitted and received among these elements.

In the document-search supporting apparatus 1, when a user turns on the electric power thereof, the CPU 101 runs a program that is called a loader and is stored in the ROM 102. A program that is called an Operating System (OS) and manages hardware and software in the computer is read from the HDD 104 into the RAM 103 so that the OS is activated. The OS runs a program according to an operation by the user, reads information, and stores information. A typical example of an OS is Windows (registered trademark). Operation programs that run on such an OS are called application programs. Application programs include not only programs that operate on a predetermined OS, but also programs that cause an OS to take over execution of a part of various types of processes described later, as well as programs that are contained in a group of program files that constitute predetermined application software or an OS.

The document-search supporting apparatus 1 has a document-search supporting program stored in the HDD 104, as an application program. In this sense, the HDD 104 functions as a storage medium that has stored therein the document-search supporting program.

Generally, each of the application programs to be installed in the HDD 104 included in the document-search supporting apparatus 1 is recorded in one of storage media 110 including optical disks such as CD-ROMs and Digital Versatile Disks (DVDs), various types of magneto optical disks, various types of magnetic disks such as flexible disks, and media that use various methods such as semiconductor memories, so that the operation programs recorded on the storage media 110 can be installed into the HDD 104. Thus, storage media 110 that are portable, like optical information recording media such as CD-ROMs and magnetic media such as Floppy Disks (FDs), can also be each used as a storage medium for storing therein an application program. Further, it is also acceptable to install application programs into the HDD 104 after obtaining the application programs from an external source via, for example, the communication controlling device 106.

In the document-search supporting apparatus 1, when the document-search supporting program that operates on the OS is run, the CPU 101 performs various types of computation processes and controls the functional units in an integrated manner, according to the document-search supporting program. Of the various types of computation processes performed by the CPU 101 included in the document-search supporting apparatus 1, characteristic processes according to the first embodiment will be explained below.

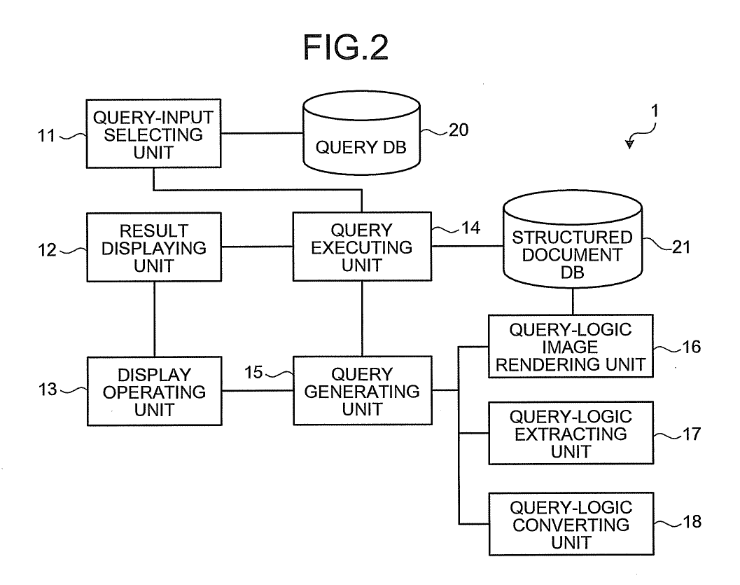

FIG. 2 is a block diagram of a schematic configuration of the document-search supporting apparatus 1. As shown in FIG. 2, according to the document-search supporting program, the document-search supporting apparatus 1 forms, in the HDD 104 serving as a storage unit, a query database (query DB) 20 that is a database for storing therein queries and a structured document database (structured document DB) 21 that is a database for storing therein structured documents having a hierarchical logical structure. A query storing unit is realized herewith. Also, according to the document-search supporting program, the document-search supporting apparatus 1 includes a query-input selecting unit 11, a result displaying unit 12, a display operating unit 13, a query executing unit 14, a query generating unit 15, a query-logic mapping unit 16, a query-logic extracting unit 17, and a query-logic converting unit 18.

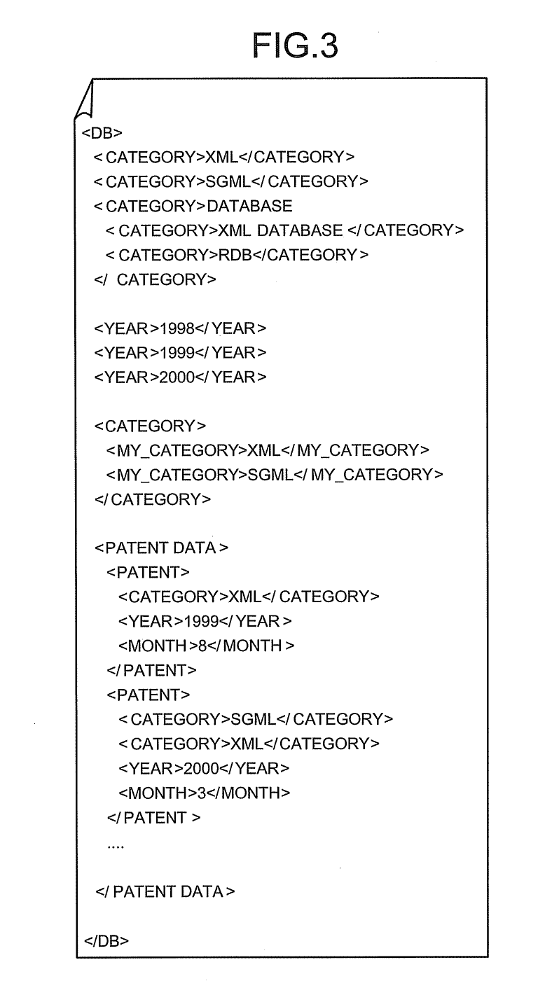

FIG. 3 is a schematic drawing of an example of structured document data stored in the structured document DB 21. A typical example of a language used for writing structured document data is eXtensible Markup Language (XML). The structured document data shown in FIG. 3 is written in XML. In XML, each of individual parts that constitute a document structure is called an “element”. Elements are written by using a tag. More specifically, each element is expressed by placing data between two tags, namely a tag (i.e., a start tag) that indicates the start of the element and a tag (i.e., an end tag) that indicates the end of the element. The text data that is placed between the start tag and the end tag is a text element (i.e., a text node) that is contained in the element expressed with the start tag and the end tag.

In the example shown in FIG. 3, there is a root element of the elements placed between <DB> tags. The following elements are directly subordinate to the “DB” element:
Three child elements each of which is placed between “CATEGORY” tags;
Three child elements each of which is placed between “YEAR” tags;
One child element that is placed between “CATEGORY” tags; and

One child element that is placed between “PATENT DATA” tags.

The “CATEGORY” elements appear directly subordinate to the “DB” element four times (i.e., three times plus one time). Subordinate to the third “CATEGORY” element are two “CATEGORY” elements that are grandchild elements thereof. Directly subordinate to the “PATENT DATA” element are a plurality of “PATENT” elements. A text element appears at each of the terminals. Subordinate to the first “CATEGORY” element is a text “XML”.

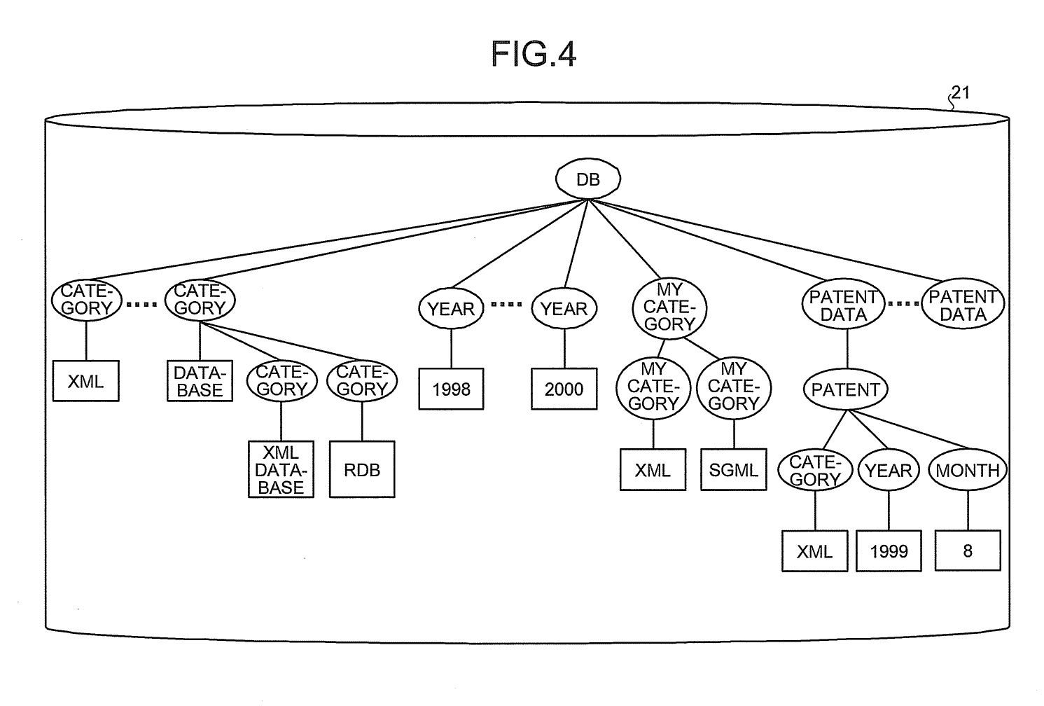

FIG. 4 is a schematic drawing of an example showing how the structured document data shown in FIG. 3 is stored in the structured document DB 21. According to the first embodiment, the structured document DB 21 is stored in the HDD 104; however, it is also possible for the structured document DB 21 to be resident in a memory.

As shown in FIG. 4, each of the nodes is stored as a piece of object data. The hierarchical relationships among the nodes are stored as being expressed as links. An identifier called an Object ID (OID) is assigned to each object. In FIG. 4, each of the nodes indicated with a square is a text node.

For example, a query language is used as a means of taking out structured document data stored in the structured document DB 21. Just like Structured Query Language (SQL) is used in the field of RDBs, the World Wide Web Consortium (W3C) has formulated XQuery (XML Query Language) for XML. XQuery is a language that is used so that XML data can be treated as a database. Thus, in XQuery, a means of taking out a data set that matches criteria as well as totaling and analyzing the data is provided. In addition, because XML data has a hierarchical structure in which parent elements, child elements, and sibling elements are combined, a means of tracing the elements in the hierarchical structure is provided in XQuery.

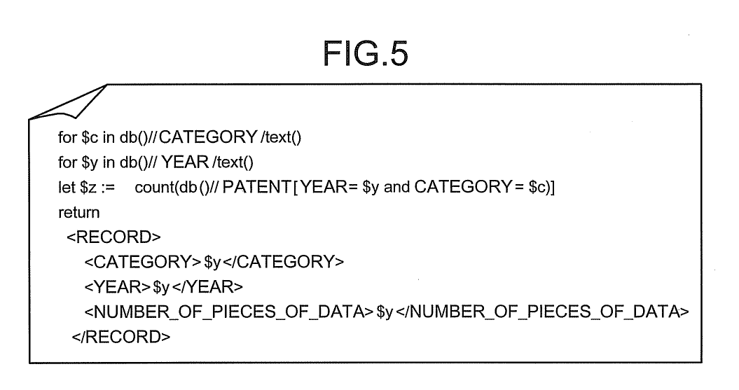

FIG. 5 is a schematic drawing of an example of a query. Queries like this are stored in the query DB 20. The query shown in FIG. 5 is in compliance with a query writing method based on XQuery. This query represents a search request that “PATENT”s should be classified and tallied by using two criteria in the structured document DB 21, the two criteria namely being “CATEGORY” and “YEAR”.

The following explains the contents of the query:
“for $c in db ( )//CATEGORY//text( )” means to set a variable to “$c” with respect to the text in “CATEGORY” on an arbitrary hierarchical level in the structured document DB and let a loop run;
“for $y in db ( )//YEAR//text( )” means to set a variable to “$y” with respect to the text in “YEAR” on an arbitrary hierarchical level in the structured document DB and let a loop run;
“let $z:=count (db( )//PATENT[YEAR=$y and CATEGORY=$c])” means to select, out of “PATENT” on an arbitrary hierarchical level in the structure document DB, pieces of data in which “YEAR” that is directly subordinate to “PATENT” is equal to the variable $y and also in which “CATEGORY” that is directly subordinate to “PATENT” is equal to the variable $c, count the number of pieces of data, and set the number as a variable $z; and
“return <RECORD> . . . </RECORD>” means to output the result as a “RECORD” element. The child elements are arranged in the order of “CATEGORY”, “YEAR”, and “NUMBER_OF PIECES_OF_DATA”, and a corresponding variable value is set for each of the child elements.

The hierarchical relationships among the elements may be expressed by one of “/” and “//”. The former expresses a parent-child relationship, whereas the latter expresses an ancestor-descendant relationship. The notation “text( )” corresponds to a text element.

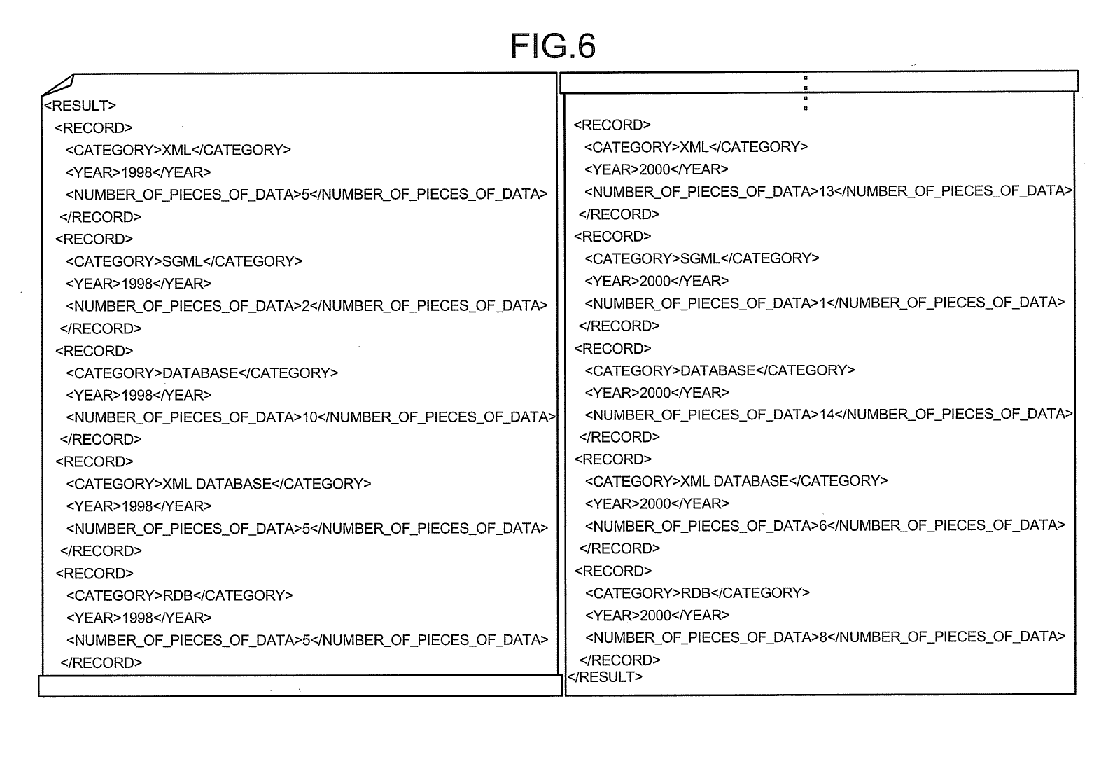

FIG. 6 is a drawing of a result obtained by having the query shown in FIG. 5 executed by the query executing unit 14 on the structured document DB 21 shown in FIG. 4. Although the result is not registered, it is also acceptable to consider the result as a new piece of structured document data. As shown in FIG. 6, subordinate to the root element “RESULT” are the elements “RECORD” that are in the format explained above. The number of pieces of data of “RECORD”s is obtained by multiplying the number of “PATENT”s by “YEAR”.

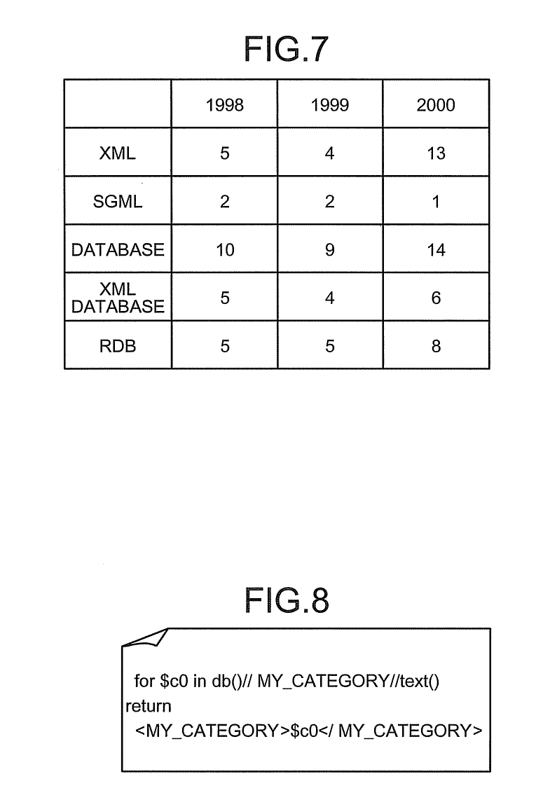

FIG. 7 is a schematic drawing for explaining how the structured document data that has been generated as the result and shown in FIG. 6 is output according to a display conversion rule called eXtensible Stylesheet Language (XSL). XSL arranges a screen and a printing format and also sets a type, by specifying a style for each structured document data. As shown in FIG. 7, the output matches the search request that “PATENT”s should be classified and tallied by using the two criteria in the structured document DB 21, the two criteria namely being “CATEGORY” and “YEAR”.

FIG. 8 is a schematic drawing of another example of a query that is different from the one shown in FIG. 5. This query represents a search request that “MY_CATEGORY”s in the structured document DB should be shown in a list.

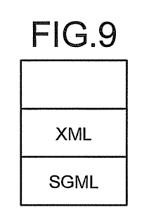

FIG. 9 is a drawing of an output obtained by having the query shown in FIG. 8 executed on the structured document DB 21 shown in FIG. 4 and applying a display conversion. As shown in FIG. 9, the texts that respectively read “XML” and “SGML [=Standard Generalized Markup Language]” are arranged in the list.

Next, the functional units that constitute a document-search supporting function of the document-search supporting apparatus 1 shown in FIG. 2 will be explained in detail.

The query-input selecting unit 11 presents an initial query set stored in the query DB 20 to a user and prompts the user to select one or more source queries.

The result displaying unit 12 executes, via the query executing unit 14, a source query or a target query on the structured document DB 21 and presents a structured document obtained as a result of the execution to the user.

The display operating unit 13 handles a user operation based on a drag-and-drop operation that has been performed on two structured documents displayed as results and generates, via the query generating unit 15, a new query (i.e., a target query) by estimating the user's intention based on the contents of the operation. This will be explained further in detail later.

The query generating unit 15 calls the query-logic mapping unit 16, the query-logic extracting unit 17, and the query-logic converting unit 18 and generates the new query (i.e., the target query).

The query-logic extracting unit 17 functions as the query-logic extracting unit defined in the claims. The query-logic extracting unit 17 extracts related parts from two source queries through a user operation. The details will be explained later.

The query-logic mapping unit 16 functions as the query-logic mapping unit defined in the claims. The query-logic mapping unit 16 generates an optimal correlating relationship between the related parts from the two source queries.

The query-logic converting unit 18 functions as the query generating unit defined in the claims. The query-logic converting unit 18 generates the new query (i.e., the target query) by applying a conversion on the source queries, based on the generated correlating relationship.

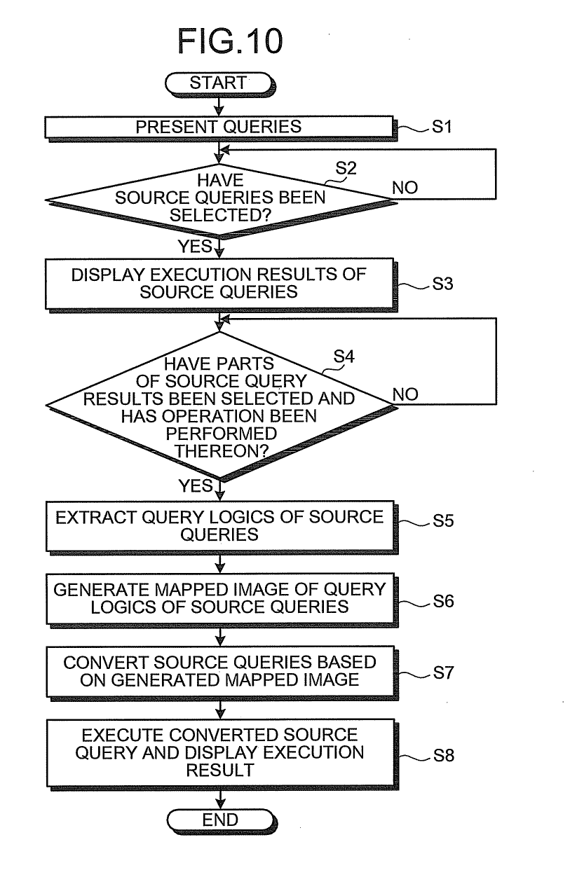

Next, the procedure in the document-search supporting process performed by the document-search supporting apparatus 1 will be explained with reference to the flowchart shown in FIG. 10. It is assumed that a plurality of queries have already been registered in the query DB 20.

At step S1, a list showing the plurality of queries (i.e., the initial query set) registered in the query DB 20 is displayed on the displaying unit 107 and presented to the user. The user is prompted to select source queries out of the list of queries via the input unit 108 (the query-input selecting unit 11). If the query is a simple one, it is possible for the user to generate the query and newly register it.

Subsequently, at step S2, it is checked to see if two source queries have been selected.

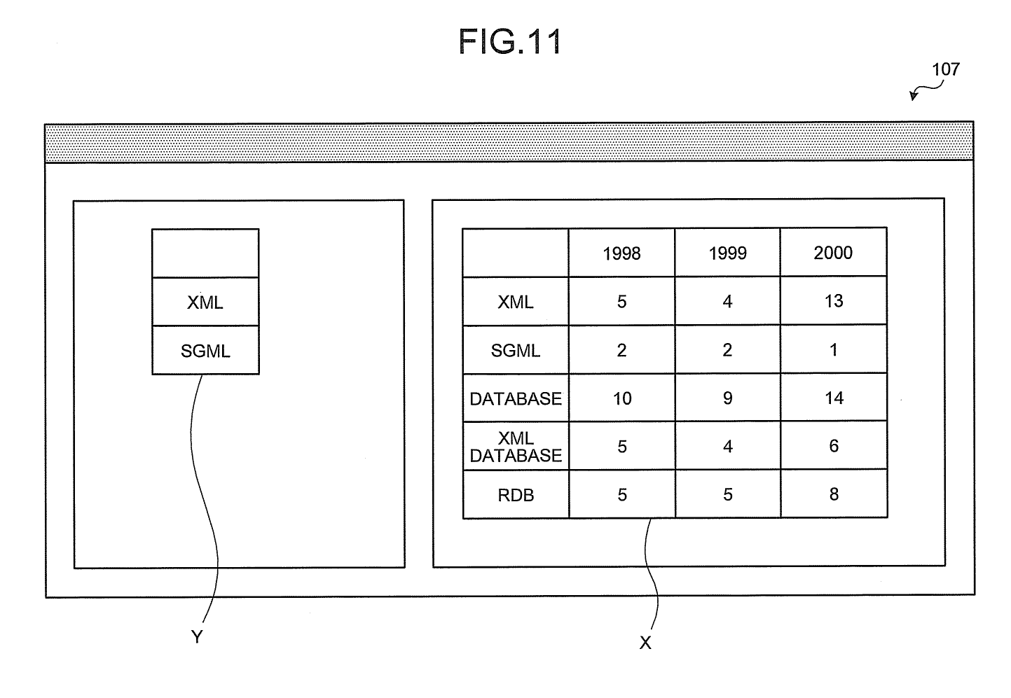

When it is judged that two source queries have been selected (step S2: Yes), execution results of the source queries are displayed on the displaying unit 107 (step S3: a result presenting unit). More specifically, the query executing unit 14 accesses the structured document DB 21 by using each of the source queries, and the result displaying unit 12 displays each of the results on the displaying unit 107. FIG. 11 is a front view of an example of query execution results displayed on the displaying unit 107. In the display in FIG. 11, an example in which the query shown in FIG. 5 and the query shown in FIG. 8 have been selected as the source queries are shown. As shown in FIG. 11, displayed on the screen are the pieces of structured document data shown in FIGS. 7 and 9, in other words, results X and Y obtained by executing the queries shown in FIGS. 5 and 8. The screen is divided into two sub-screens. The results X and Y obtained by executing the queries shown in FIGS. 5 and 8 are displayed thereon, respectively.

Next, at step S4, it is checked (by the display operating unit 13) to see if parts of the execution results of the source queries have been selected and an operation has been performed thereon. The operation in this process is based on a drag-and-drop operation. The display operating unit 13 handles the user operation based on a drag-and-drop operation performed on the displayed execution results of the two queries.

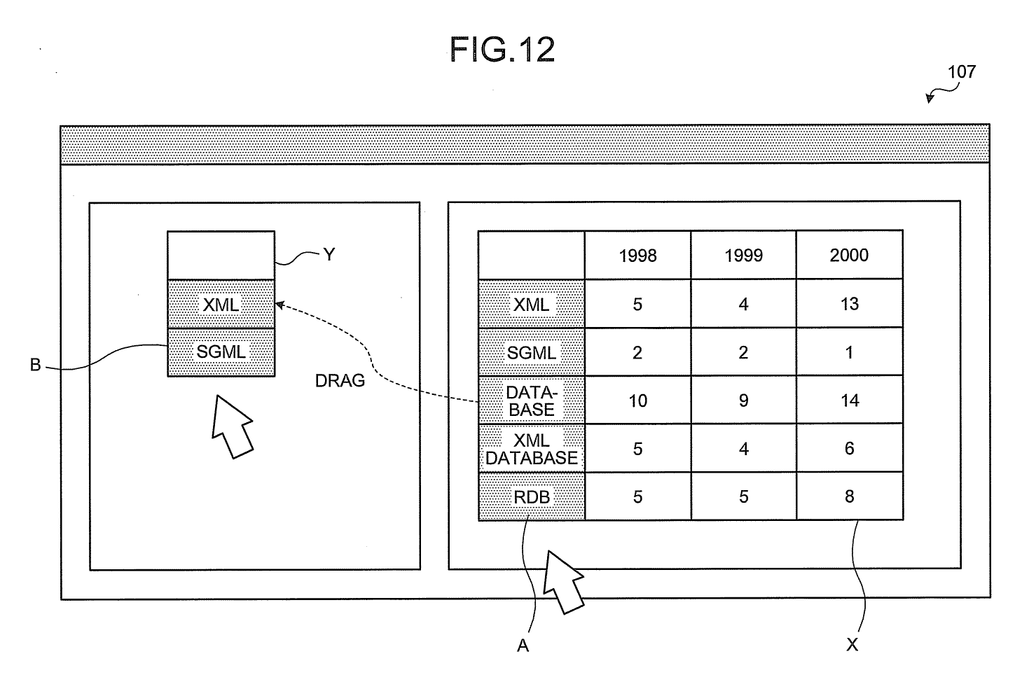

FIG. 12 is a schematic drawing of an example of the user operation performed on the displayed execution results of the two queries. In FIG. 12, it is shown that an area indicated with hatching is selected out of the display in FIG. 11, by using the input unit 108 such as a mouse. More specifically, the column including “XML”, “SGML”, . . . and “RDB” in the execution result X of the query shown in FIG. 5 displayed on the sub-screen on the right-hand side is selected (grabbed) by using the input unit 108 such as the mouse. This area will be referred to as a selected area A. After that, the column including “XML” and “SGML” in the execution result Y of the query shown in FIG. 8 displayed on the sub-screen on the left-hand side is selected by using the input unit 108 such as the mouse, while a control (CTL) key on a keyboard that is also included in the input unit 108 is being pushed. This area will be referred to as a selected area B. Subsequently, the selected area A is re-selected by using the input unit 108 such as the mouse and is moved (dragged) to the selected area B while the mouse button is being pushed. As a result of the operation described here, it is judged that parts of the execution results of the source queries have been selected, and further, an operation has been performed thereon. The function of a correlating unit is realized herewith.

When it is judged that parts of the execution results of the source query and the target query have been selected, and further, an operation has been performed thereon (step S4: Yes), the user's intention is estimated based on the contents of the operation performed at step S4, so that a new query (i.e., a target query) is generated (by the query generating unit 15) at steps S5 through S7.

At step S5, a query logic is extracted from each of the source queries (by the query-logic extracting unit 17). More specifically, a related part is extracted as a query logic from each of the source queries, based on the contents of the operation.

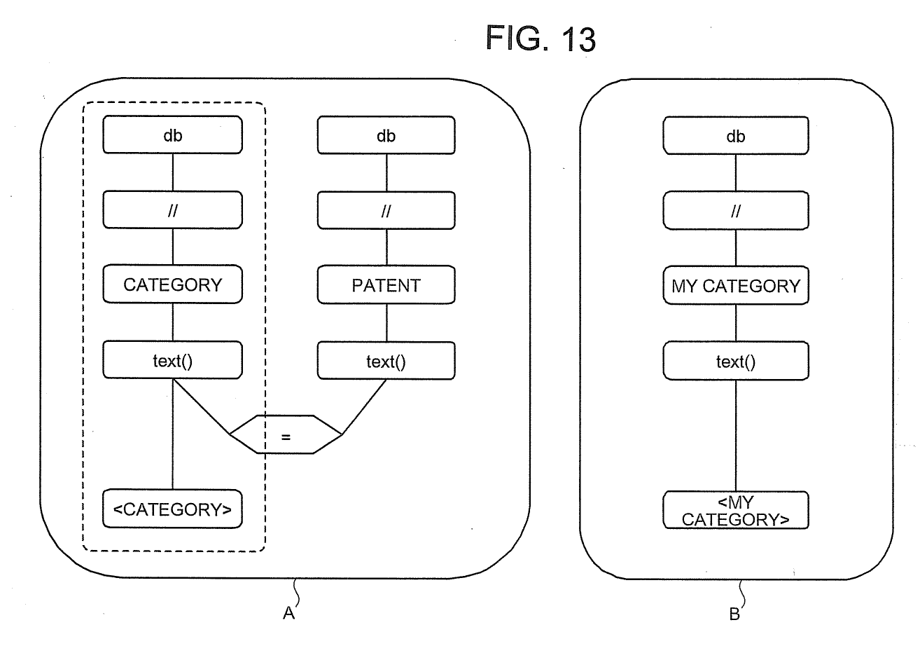

Next, a method for estimating the user's intention will be explained with reference to FIG. 13. FIG. 13 is a drawing of query logics that respectively correspond to the selected area A and the selected area B shown in FIG. 12. Each of the query logics is a graph that is made up of the following constituent elements:
specification of a tag, e.g., “db”, “CATEGORY”, “text ( )”;
hierarchical relationship between elements, e.g., “/”, “//”;
data comparison, e.g., “=”; and
specification of an output tag, e.g., “<CATEGORY>”

In FIG. 13, the part that corresponds to the output in the selected area A is “<CATEGORY>”, whereas the part that corresponds to the output in the selected area B is “<MY_CATEGORY>”. The query logics are extracted on a basis that, for example, “text( )” outputs the text in the “<CATEGORY>” and that a parent tag thereof is “CATEGORY”. This process is performed by the query-logic extracting unit 17.

The graph shown on the left-hand side of FIG. 13 does not represent the entire query shown in FIG. 5. A partial graph that is related only to the selected area A is extracted as the query logic. The part indicated with a broken line shows, in particular, a path for deriving the output “<CATEGORY>” (called a “derivation logic”). Similarly, in the graph shown on the right-hand side of FIG. 13, the part that is related only to the selected area B is extracted as the query logic.

At step S6, a mapped image of the query logics of the source queries is generated (by the query-logic mapping unit 16). More specifically, an optimal correlating relationship between the related parts in the two source queries (i.e., between the query logics) is generated. There is a possibility that a plurality of correlating relationships are generated. In such a situation, the query-logic mapping unit 16 specifies an evaluation function related to “a degree of structural similarity” and “a degree of coincidence in data” that structure the query logics, accesses the structured document DB 21 to evaluate the correlating relationships, and selects the best correlating relationship based on the result of the evaluation.

More specifically, the query logic shown on the left-hand side of FIG. 13 is compared with the query logic shown on the right-hand side of FIG. 13. In particular, by comparing the derivation logic on the left-hand side with the query logic on the right-hand side, the following relationship is obtained:

<db( )//CATEGORY/text( ), db( )//MY_CATEGORY/text( )><<CATEGORY>, <MY_CATEGORY>>

<CATEGORY,MY_CATEGORY>

In this correlating relationship, there is no conflict.

At step S7, based on the rendered image (i.e., the optimal correlating relationship) generated at step S6, a conversion process is applied to the source queries so that a new query is generated (by the query-logic converting unit 18).

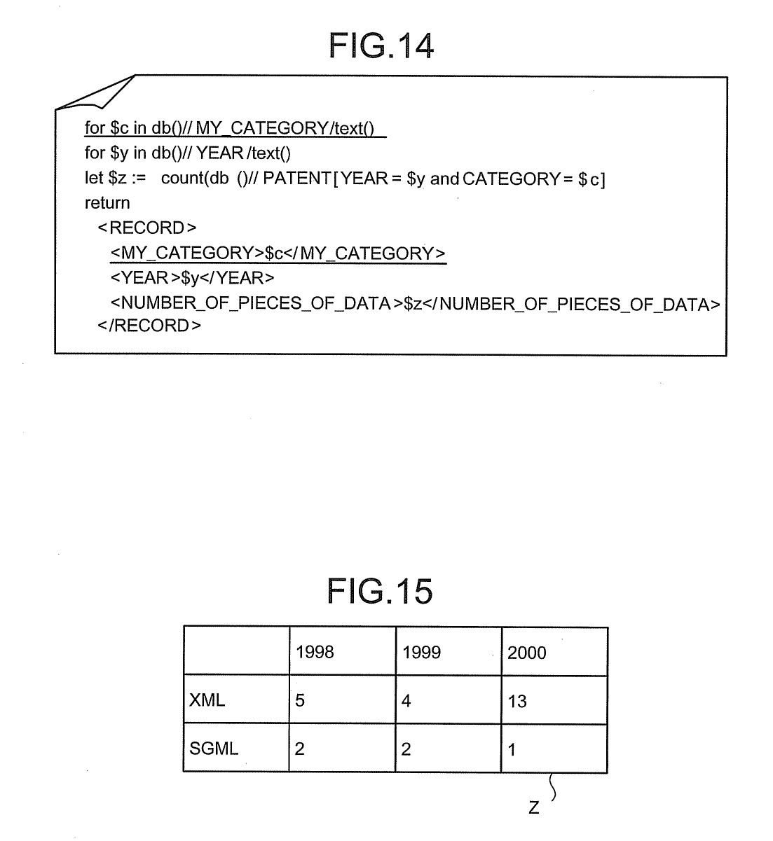

In FIG. 14, a query that is obtained as a result of the conversion process performed on the query in FIG. 5 by using the rendered image of the query logics generated at step S6 is shown. The query shown in FIG. 14 represents a search request that “PATENT”s should be classified and tallied by using two criteria in the structured document DB 21, the two criteria namely being “MY_CATEGORY” and “YEAR”.

The following explains the contents of the query:
“for $c in db ( )//MY_CATEGORY//text( )” means to set a variable to “$c” with respect to the text in “MY_CATEGORY” on an arbitrary hierarchical level in the structured document DB 21 and let a loop run;
“for $y in db ( )//YEAR//text( )” means to set a variable to “$y” with respect to the text in “YEAR” on an arbitrary hierarchical level in the structured document DB and let a loop run;
“let $z:=count (db( )//PATENT[YEAR=$y and CATEGORY=$c])” means to select, out of “PATENT” on an arbitrary hierarchical level in the structured document DB, pieces of data in which “YEAR” that is directly subordinate to “PATENT” is equal to the variable $y and also “CATEGORY” that is directly subordinate to “PATENT” is equal to the variable $c, count the number of pieces of data, and set the number as a variable $z; and
“return <RECORD> . . . </RECORD>” means to output the result as a “RECORD” element. The child elements are arranged in the order of “MY_CATEGORY”, “YEAR”, and “NUMBER_OF PIECES_OF_DATA”, and a corresponding variable value is set for each of the child elements.

The query shown in FIG. 14 seems to have a syntax that is very similar to that of the query shown in FIG. 5; however, the following conversion has been performed:
CATEGORY→MY_CATEGORY
   This correlating relationship will be expressed as <CATEGORY,MY_CATEGORY>.

When the query shown in FIG. 14 is compared, it is understood that there is a correlating relationships as shown below that does not conflict with the correlating relationship explained above:

<db( )//CATEGORY/text( ), db( )//MY_CATEGORY/text( )>
<<CATEGORY>, <MY_CATEGORY>>

More specifically, as a result of the user operation shown in FIG. 12, the user's intention that he/she would like to have “CATEGORY” corresponding to “XML”, “SGML”, . . . “RDB” replaced with “MY_CATEGORY” corresponding to the “XML” and “SGML” is estimated.

At step S8, the source query obtained as a result of the conversion process performed at steps S5 through S7 is executed, and an execution result is displayed. The function of a searching unit and the function of the result presenting unit are realized herewith. FIG. 15 is the execution result that is displayed on a new screen as a result of the operation shown in FIG. 12. It is understood from the drawing that structured document data Z that is different from the pieces of structured document data shown in FIGS. 7 and 9 described above has been generated.

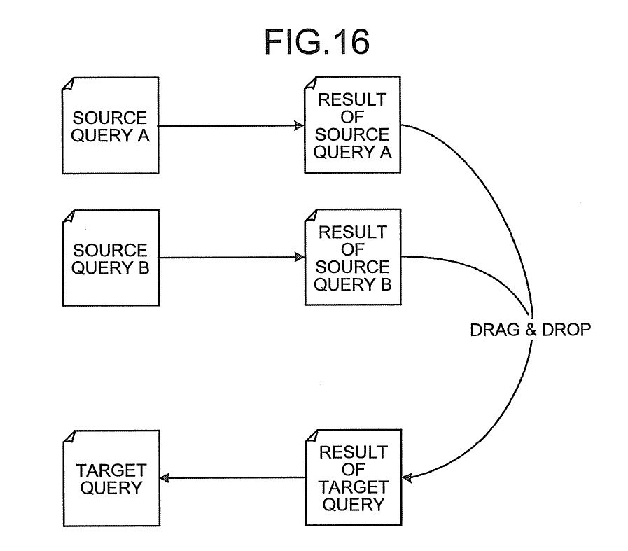

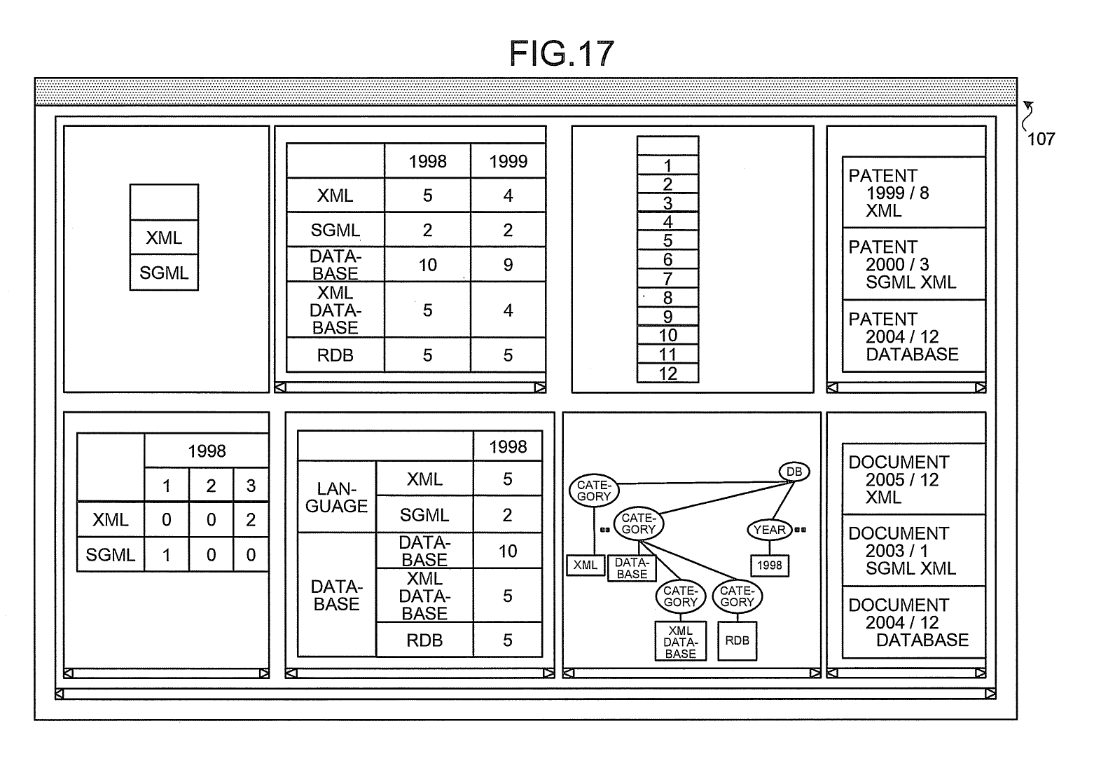

In other words, according to the first embodiment, as shown in FIG. 16, the user is prompted to select two source queries at first. Then, a searching process is performed on the structured document DB 21 by using each of the two selected source queries so that result of source query are presented. With regard to predetermined structural parts from the result of source query obtained by using the two source queries, when the predetermined structural part from one of the two result of source query is dragged and dropped onto the predetermined structural part from the other of the two result of source query, the target query that is the new query as well as a search result obtained by using the target query are generated by bringing the predetermined structural parts from the result of source query obtained by using the two source queries into correspondence with each other. More specifically, according to the first embodiment, a support for searching in the structured document is provided by generating the new query while an interaction is performed with the user.

As explained above, according to the first embodiment, there is no need to prepare an extremely large number of detailed synthesis rules in advance before generating the new query. It is possible to generate a complex search formula by repeatedly performing the simple operation of selecting the predetermined structural parts out of the two result of source query and bringing the selected predetermined structural parts into correspondence with each other.

Also, it is possible to perform the operation of selecting the predetermined structural parts out of the two result of source query and bringing the selected predetermined structural parts into correspondence with each other, by performing an intuitive operation such as a drag-and-drop operation. Thus, it is possible to generate a complex search formula by performing the simple operation.

Further, the user is not required to have basic knowledge such as information related to the syntax and information related to the data structures (i.e., the schemas).

In addition, according to the first embodiment, the list showing the plurality of queries (i.e., the initial query set) that have been registered in the query DB 20 is displayed on the displaying unit 107 and presented to the user. The user is prompted to select source queries out of the list of queries via the input unit 108 (by the query-input selecting unit 11). The execution results of the source query and the target query are then displayed on the displaying unit 107. However, the present invention is not limited to this arrangement. Another arrangement is acceptable in which, as shown in FIG. 17, execution results of the plurality of queries registered in the query DB 20 are displayed in a list on the displaying unit 107, so that the user is prompted to select source queries and a target query out of the displayed list.

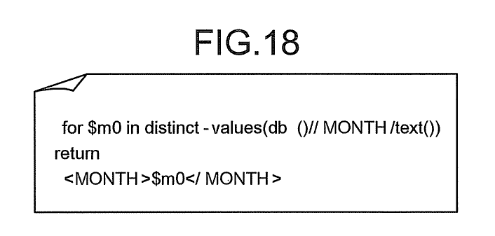

Next, a second embodiment of the present invention will be explained with reference to FIGS. 18 to 26. The functional units that are the same as those in the first embodiment will be referred to by using the same reference characters, and the explanation thereof will be omitted.

According to the second embodiment, after the query-logic mapping unit has generated a plurality of matching candidates, one of the matching candidates is selected.

FIG. 18 is a schematic drawing of an example of a query according to the second embodiment of the present invention.

The query shown in FIG. 18 represents a search request that “MONTH”s in the structured document DB 21 should be shown in a list. In the query, “distinct-values” denotes a function for having a unique text set generated by using a text set that matches a specified criterion as an input.

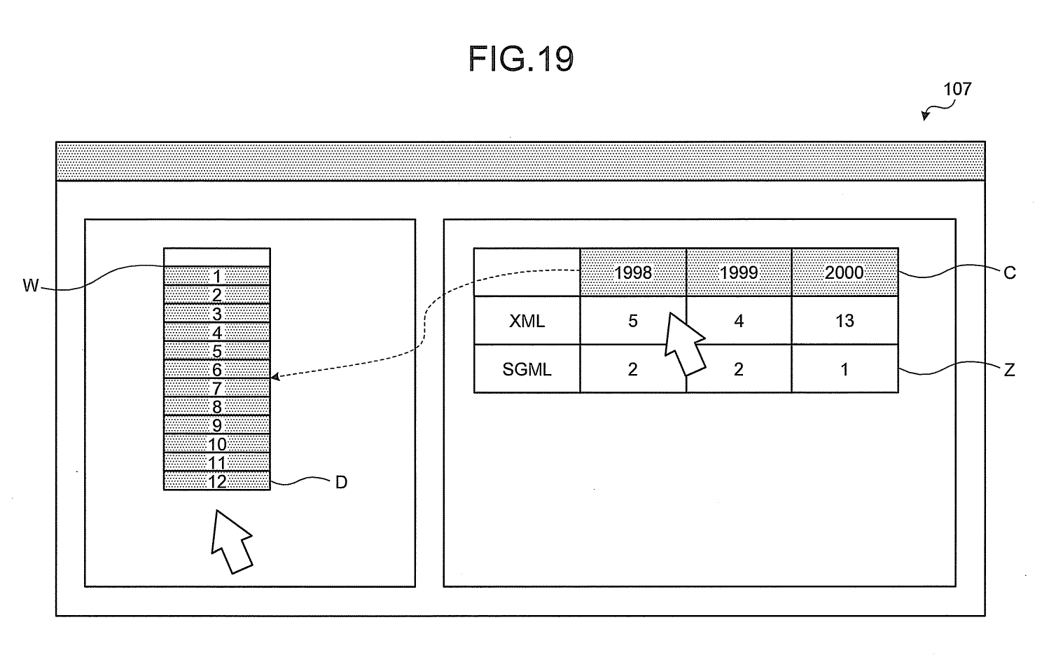

FIG. 19 is a schematic drawing of an example of a user operation performed on the displayed execution results of two queries. In FIG. 19, it is shown that an area indicated with hatching is selected by using the input unit 108 such as a mouse. More specifically, the column including “1998”, “1999”, and “2000” in the query execution result Z shown in FIG. 15 (cf. the first embodiment) displayed on the sub-screen on the right-hand side is selected (grabbed) by using the input unit 108 such as the mouse. This area will be referred to as a selected area C. After that, the column including “1”, “2”, . . . , and “12” in the query execution result W displayed on the sub-screen on the left-hand side is selected by using the input unit 108 such as the mouse, while a CTL key on a keyboard that is also included in the input unit 108 is being pushed. This area will be referred to as a selected area D. The query execution result W displayed on the sub-screen on the left-hand side is an output obtained by executing the query shown in FIG. 18 on the structured document DB 21 shown in FIG. 4 and applying a displaying conversion. Subsequently, the selected area C is re-selected by using the input unit 108 such as the mouse and is moved (dragged) to the selected area D while the mouse button is being pushed. As a result of the operation described here, it is judged that parts of the execution results of the source queries have been selected, and further, an operation has been performed thereon (FIG. 10, step S4: Yes).

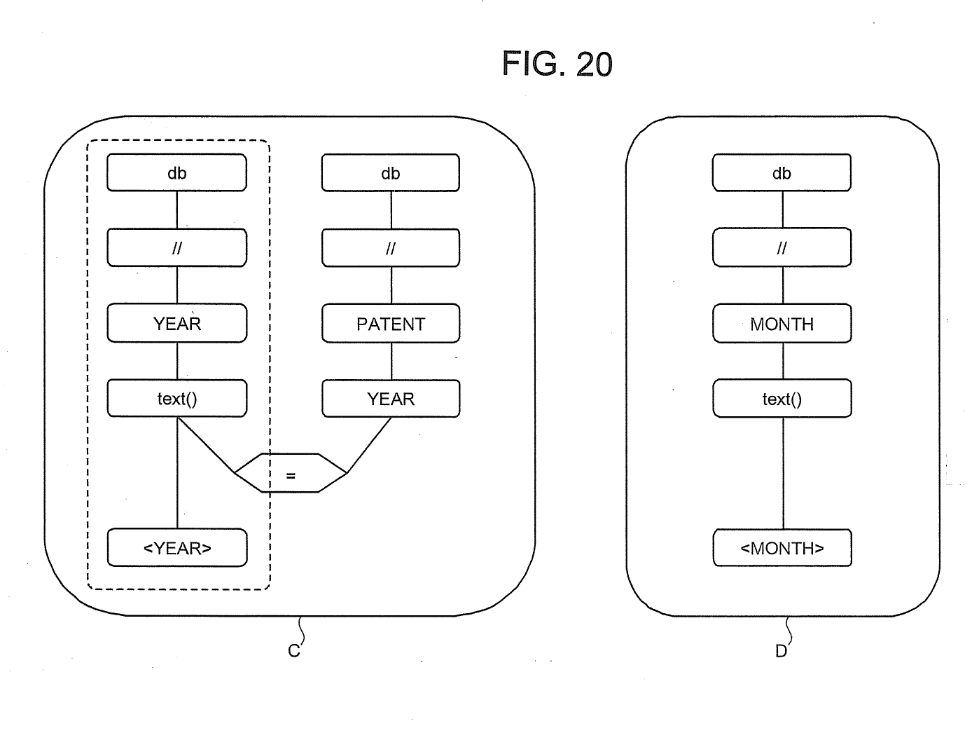

FIG. 20 is a drawing of query logics that respectively correspond to the selected area C and the selected area D in FIG. 17. In FIG. 20, the part that corresponds to the output in the selected area C is “<YEAR>”, whereas the part that corresponds to the output in the selected area D is “<MONTH>”. The query logics are extracted on a basis that, for example, “text( )” outputs the text in the “<YEAR>” and that a parent tag thereof is “YEAR”. This process is performed by the query-logic extracting unit 17 (FIG. 10, step S5).

The graph shown on the left-hand side of FIG. 20 does not represent the entire query shown in FIG. 14. A partial graph that is related only to the selected area C is extracted as the query logic. The part indicated with a broken line shows, in particular, a path for deriving the output “CATEGORY” (called a “derivation logic”). Similarly, in the graph shown on the right-hand side of FIG. 20, the part that is related only to the selected area D is extracted as the query logic.

Next, the query logic shown on the left-hand side of FIG. 20 is compared with the query logic shown on the right-hand side of FIG. 20. In particular, when the derivation graph on the left-hand side is compared with the query logic on the right-hand side, the following relationship is obtained:

<db( )//YEAR/text( ), db( )//MONTH/text( )>
<<YEAR>, <MONTH>>
<db( )//PATENT/YEAR, db( )//PATENT/MONTH>

In this correlating relationship, there is no conflict.

Subsequently, a rendered image of the query logics of the source queries is generated by the query-logic mapping unit 16 (FIG. 10, step S6).

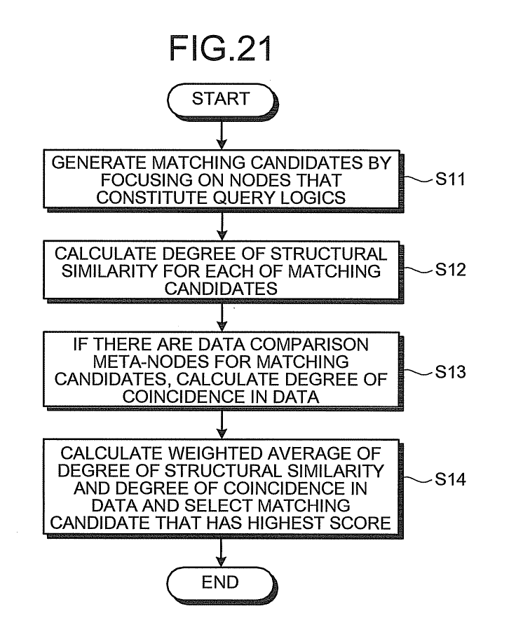

FIG. 21 is a flowchart of the operation performed by the query-logic mapping unit 16. As shown in FIG. 21, the query-logic mapping unit 16 generates matching candidates by focusing on the nodes that constitute the query logics (step S11), calculates a degree of structural similarity for each of the matching candidates (step S12), and calculates a degree of coincidence in the data if there are data comparison meta-nodes for the matching candidates (step S13). Finally, a weighted average of the degree of structural similarity calculated at step S12 and the degree of coincidence in the data calculated at step S13 is calculated, so that one of the matching candidates that has the highest score is selected (step S14). The degree of structural similarity has meanings as shown below:
“ELEMENT” denotes the degree of similarity in the correlating relationships;
“CONSISTENCY” denotes the consistency in the correlating relationships of the elements; and
“TOTAL” denotes a sum of the scores for “ELEMENT” and “CONSISTENCY”

The degree of coincidence in the data has a meaning as shown below:
the degree of successfulness in data comparison, e.g., indicated by “=”

The total score is obtained by calculating a weighted average. “CONSISTENCY” is weighted by “4”.

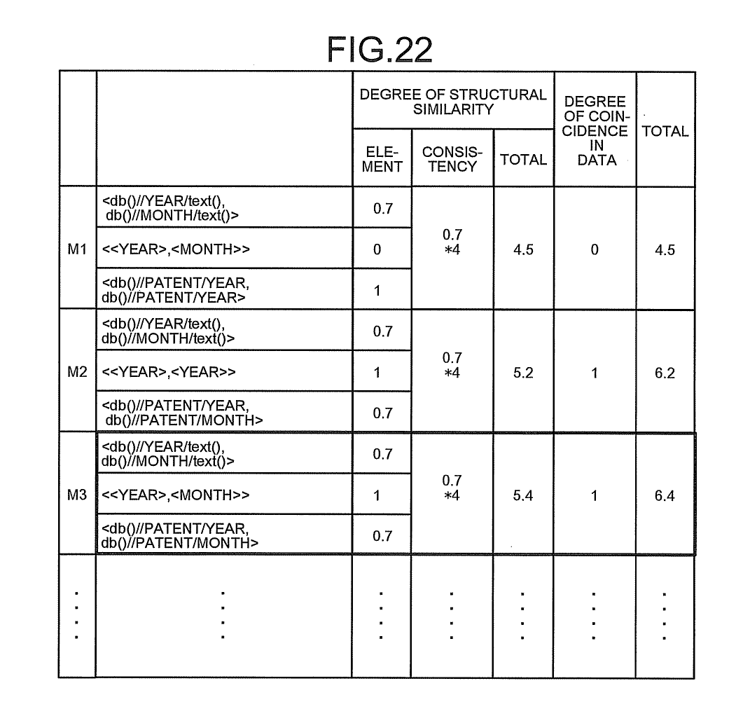

Next, a more specific example will be explained. In this example, the query logic shown on the left-hand side of FIG. 20 is compared with the query logic shown on the right-hand side of FIG. 20. In particular, when the derivation graph on the left-hand side is compared with the query logic on the right-hand side, three matching candidates are generated. FIG. 22 is a drawing for illustratively explaining the matching candidates. In FIG. 22, the degree of structural similarity, the degree of coincidence in the data, and the total of the degree of structural similarity and the degree of coincidence in the data are shown for each of the matching candidates (M1, M2, M3, and so on).

The matching candidate M1 includes the following:
<db( )//YEAR/text( ), db( )//MONTH/text( )>: correspondence in the “for” nodes in the query logics;
<<YEAR>, <MONTH>>: correspondence in the “return” nodes and the output parts in the query logics; and
<db( )//PATENT/YEAR, db( )//PATENT/YEAR>: this component is used as it is because it is included in the query logic on the left-hand side but is not included in the query logic on the right-hand side.

The matching candidate M2 includes the following:
<db( )//YEAR/text( ), db( )//MONTH/text( )>: correspondence in the “for” nodes in the query logics;
<<YEAR>, <YEAR>>: the query logic on the left-hand side is used as it is; and
<db( )//PATENT/YEAR, db( )//PATENT/MONTH>:

Because the correlating relationship above shows that <YEAR, MONTH> is in correspondence, the query is generated by substituting the corresponding portion.

The matching candidate M3 includes the following:
<db( )//YEAR/text( ), db( )//MONTH/text( )>: correspondence in the “for” nodes in the query logics;
<<YEAR>, <MONTH>>: Based on the correlating relationship above, the relationship stating that <YEAR, MONTH> is in correspondence is extracted; and
<db( )//PATENT/YEAR, db( )//PATENT/MONTH>: Because the correlating relationship above shows that <YEAR, MONTH> is in correspondence, the query is generated by substituting the corresponding portion.

Next, the degree of structural similarity, the degree of coincidence in the data, and the total of the degree of structural similarity and the degree of coincidence in the data will be explained for each of the matching candidates shown above.

In the matching candidate M1, the scores are given as follows:
<db( )//YEAR/text( ), db( )//MONTH/text( )>: Because two thirds of the elements are in correspondence with each other, the score is 0.7 (rounded off to the first decimal place);
<<YEAR>, <MONTH>>: Because there is no correspondence, the score is 0;
<db( )//PATENT/YEAR, db( )//PATENT/YEAR>: Because two thirds of the elements are in correspondence with each other, the score is 0.7 (rounded off to the first decimal place);
In the correlating relationship <YEAR, MONTH>, because two thirds of the structures are in correspondence with each other, the score is 0.7, and because the weight is 4, a weighted score is 0.7×4; and
The degree of coincidence in the data “db( )//YEAR/text( )=db( )//MONTH/text( )” is 0, because the degree of successfulness in the data comparison achieved by accessing the structured document DB is 0. Thus, a sum of the degree of structural similarity, the degree of coincidence in the data, and the total of the degree of structural similarity and the degree of coincidence in the data is calculated. As a result, the matching candidate M3 has the highest score, which is 6.4. Accordingly, the matching candidate M3 is selected as the matching candidate that has the highest score.

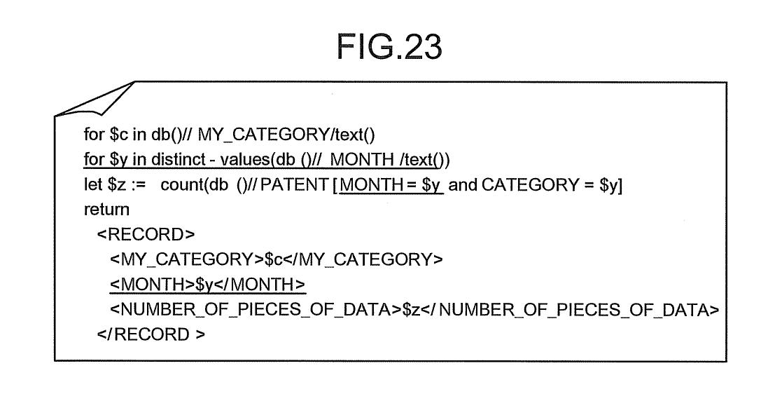

The query shown in FIG. 23 is a result obtained by having the matching candidate M3 converted by the query-logic converting unit 18. The query shown in FIG. 23 represents a search request that “PATENT”s should be classified and tallied by using two criteria in the structured document DB 21, the two criteria namely being “MY_CATEGORY” and “MONTH”. As for “MONTH”, a unique text set is generated for a text set that matches the specified criterion, by using the distinct-values.

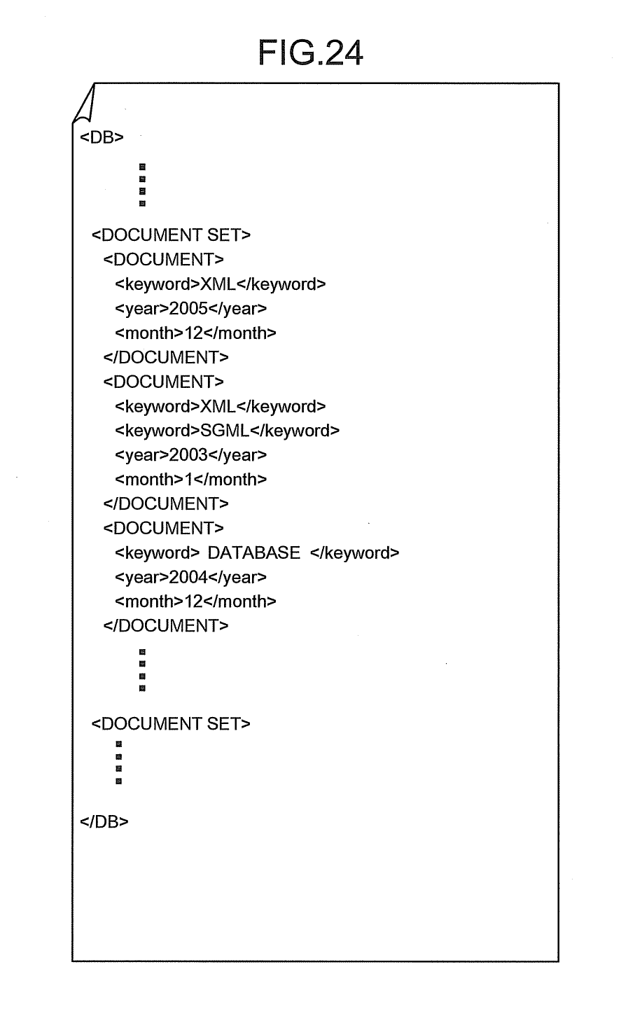

FIG. 24 is a drawing of a result obtained by having the query shown in FIG. 23 executed on the structured document DB 21 shown in FIG. 4 by the query executing unit 14.

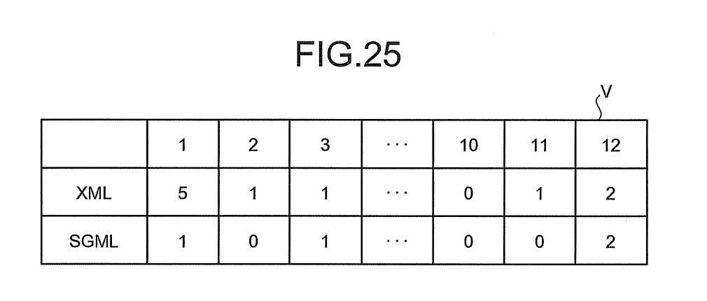

FIG. 25 is a schematic drawing for explaining how structured document data generated as the result in FIG. 24 is output according to the display conversion rule called eXtensible Stylesheet Language (XSL). It is understood from the drawing that structured document data V that is different from the pieces of structured document data shown in FIG. 17 has been generated.

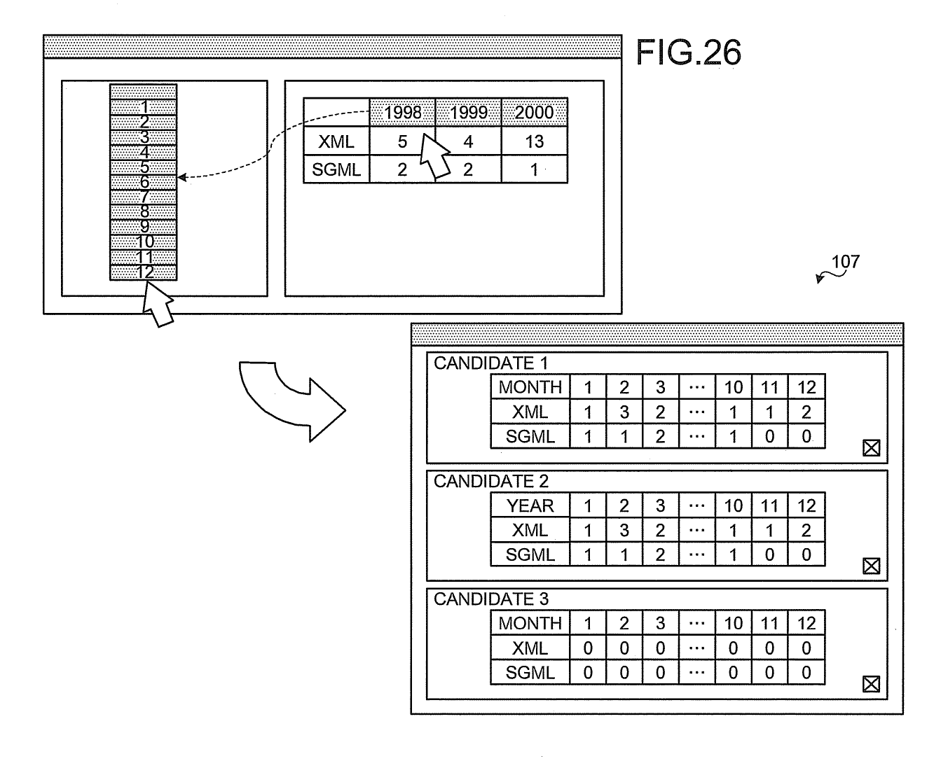

According to the second embodiment, one matching candidate is automatically selected out of the plurality of matching candidates. However, the present invention is not limited to this arrangement. Another arrangement is acceptable in which, when there are a plurality of matching candidates, the query-logic mapping unit 16 presents the plurality of matching candidates to the user, as shown in FIG. 26, and receives a selection instruction from the user.

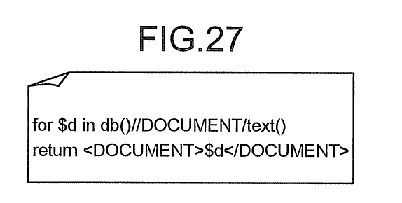

Next, a third embodiment of the present invention will be explained, with reference to FIGS. 27 to 30. The functional units that are the same as those in the first embodiment or the second embodiment will be referred to by using the same reference characters, and the explanation thereof will be omitted.

FIG. 27 is a schematic drawing of an example of a query. This query represents a search request that “DOCUMENT”s in the structured document DB 21 should be shown in a list.

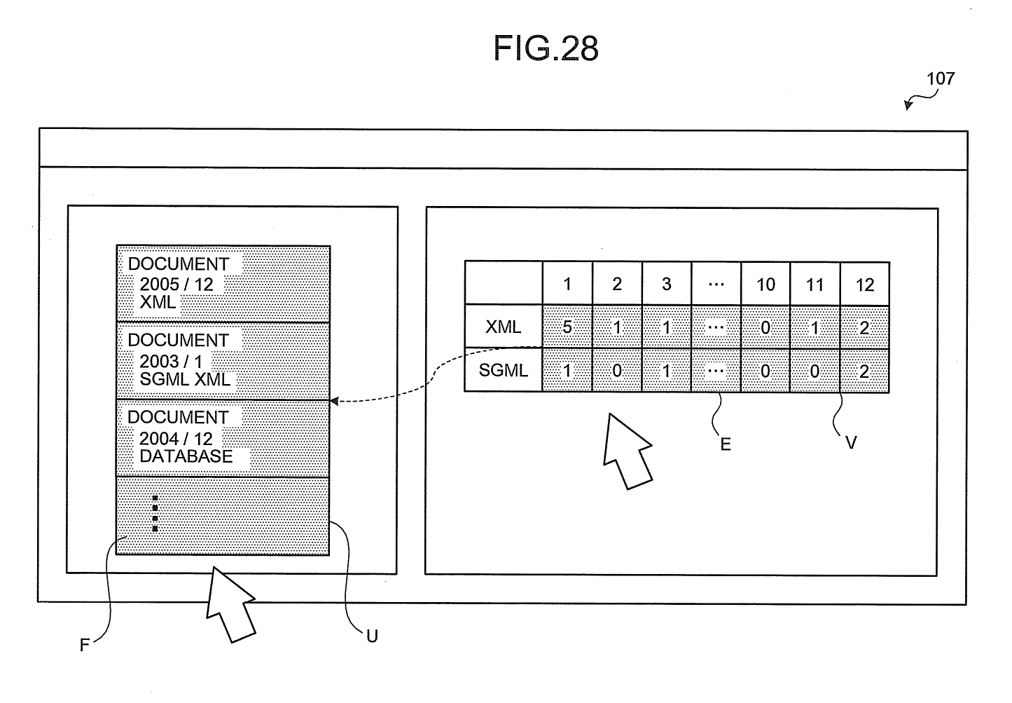

FIG. 28 is a schematic drawing of an example of a user operation performed on the two query execution results that are displayed. The query execution result U displayed on the sub-screen on the left-hand side in FIG. 28 is an output obtained by having the query shown in FIG. 27 executed on the structured document DB 21 shown in FIG. 4 by the query executing unit 14 and applying a display conversion. In FIG. 28, it is shown that an area indicated with hatching is selected by using the input unit 108 such as a mouse. More specifically, the column including “5”, “1”, . . . “2”, and “2” in the query execution result V shown in FIG. 25 (cf. the second embodiment) displayed on the sub-screen on the right-hand side is selected (grabbed) by using the mouse or the like. This area will be referred to as a selected area E. After that, the column including “DOCUMENT 2005/12 XML” and “DOCUMENT 2003/1 SGML XML” and so on in the query execution result U displayed on the sub-screen on the left-hand side is selected by using the input unit 108 such as the mouse, while a CTL key on a keyboard that is also included in the input unit 108 is being pushed. This area will be referred to as a selected area F. Subsequently, the selected area E is re-selected by using the input unit 108 such as the mouse and is moved (dragged) to the selected area F while the mouse button is being pushed. As a result of the operation described here, it is judged that parts of the execution results of the source queries have been selected, and further, an operation has been performed thereon (FIG. 10, step S4: Yes).

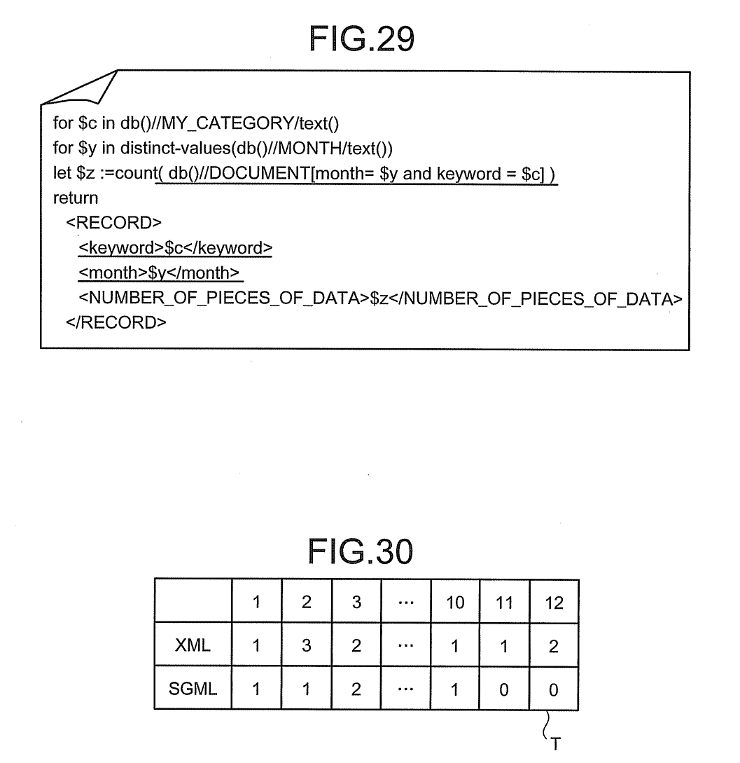

FIG. 29 is a drawing of a new query that is generated by the query generating unit 15 after the user's intention is estimated based on the contents of the operation performed at step S4. This query represents a search request that “DOCUMENT”s should be classified and tallied by using two criteria in the structured document DB 21, the two criteria namely being “MY_CATEGORY” and “MONTH”. It is understood from the drawing that “PATENT”, “CATEGORY”, and “MONTH (in Japanese)” are rendered and converted into “DOCUMENT”, “keyword”, and “month (in English)” respectively.

FIG. 30 is a drawing of an execution result displayed on a new screen as a result of the operation shown in FIG. 28. It is understood from the drawing that structured document data T that is different from the pieces of structured document data shown in FIG. 28 has been generated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document-search supporting apparatus comprising:
a query storing unit that stores queries to be used in a searching process into a storage unit, the searching process being performed on a structured document database that has a hierarchical logical structure and stores a structured document;
a correlating unit that selects predetermined structural parts of source query results and correlates the selected predetermined structural parts one another, by using at least two of the queries;
a query-logic extracting unit that extracts partial graphs respectively related to the correlated two of the predetermined structural parts of the source query results as query logics;
a query-logic mapping unit that generates a correlating relationship between the query logics; and
a query generating unit that generates a new query by converting the queries corresponding to the source query results selected by the correlating unit, based on the generated correlating relationship.

2. The apparatus according to claim 1, further comprising:
a searching unit that performs a searching process on the structured document database by using the new query; and
a result presenting unit that presents a search result.

3. The apparatus according to claim 1, wherein
the correlating unit correlates the predetermined structural parts one another, when an operation is performed so that the predetermined structural part from one of the two source query results is dragged and dropped onto the predetermined structural part from the other of the two source query results, within the predetermined structural parts from two of the source query results that are presented by the result presenting unit.

4. The apparatus according to claim 1, wherein
the query-logic mapping unit specifies an evaluation function related to a degree of structural similarity and to a degree of coincidence in data that constitute the query logics, and generates the correlating relationship according to a result of an evaluation performed on the structured document database by using the evaluation function.

5. The apparatus according to claim 1, wherein
the query-logic mapping unit makes one of the candidates selectable when there are a plurality of candidates for the correlating relationship between the query logics.

6. The apparatus according to claim 1, wherein
the result presenting unit includes:
a unit that selects at least two queries from the queries stored in the storage unit;
a unit that performs a searching process on the structured document database by using each of the at least two selected queries; and
a unit that presents source query results respectively obtained by using the at least two selected queries.

7. A computer program product having a computer readable medium including programmed instructions for supporting generation of queries to be used in a searching process performed on a structured document database that has a hierarchical logical structure and stores a structured document, wherein the instructions, when executed by a computer, cause the computer to perform:
storing the queries into a storage unit;
selecting predetermined structural parts of source query results and correlating the selected predetermined structural parts one another, by using at least two of the queries;
extracting partial graphs respectively related to the correlated two of the predetermined structural parts of the source query results as query logics;
generating a correlating relationship between the query logics; and
generating a new query by converting the queries corresponding to the source query results selected in the selecting, based on the generated correlating relationship.
